(19) United States
(12) Patent Application Publication
(10) Pub. No.: US 2025/0078622 A1
(43) Pub. Date: Mar. 6, 2025

(54) MANAGING WAGERING GAME PROGRESS USING CRYPTOGRAPHIC TOKENS

(71) Applicant: IGT, Las Vegas, NV (US)

(72) Inventors: Karen VAN NIEKERK, Dieppe (CA); Todd GRIMM, Riverview (CA); Anthony BAERLOCHER, Henderson, NV (US); David SMALL, Moncton (CA); Bethany PLIMMER, Lower Coverdale (CA); Aaron COREY, Moncton (CA); Daniel LANDRY, Moncton (CA)

(73) Assignee: IGT, Las Vegas, NV (US)

(21) Appl. No.: 18/457,020

(22) Filed: Aug. 28, 2023

(51) Int. Cl. G07F 17/32; G06Q 20/36; G06Q 20/38; G06Q 50/34

(52) U.S. Cl. CPC G07F 17/3267; G06Q 20/367; G06Q 20/3827; G06Q 20/389; G06Q 50/34; G07F 17/3239; G07F 17/3258

(57) ABSTRACT

A cryptographic token associated with a player including a cryptographic hash associated with a blockchain, a player identifier indicative of a player associated with the cryptographic token, and a progress identifier indicative of a present progress value for a wagering game is determined, and a first progress value associated with a first play session of a first wagering game by a player is determined. Based on the first progress value, the progress identifier of the cryptographic token is modified to add the first progress value to the present progress value. Based on the present progress value, a first game benefit to the player is provided.

### BACKGROUND

Embodiments described herein relate to game play features with wagering games, and in particular to managing wagering game progress using cryptographic tokens a gaming environment, such as in a casino environment, and related devices, systems, and methods. Some wagering games, such as slot games and/or video poker games provided at Electronic Gaming Machines (EGMs) in a casino environment, may include unique game features, such as in a bonus game, as an additional incentive for play of a wagering game. For example, play of the wagering game during a wagering game session at an EGM may increase a bonus game meter, such as a progressive bonus game, to increase a likelihood of and/or a size of a potential bonus game award. This progress may be associated with the EGM, such that a player ending a wagering game session without receiving a bonus game award may reduce the player's enjoyment. There is a need for providing additional options for managing wagering game progress to the player's enjoyment, excitement, and engagement.

### BRIEF SUMMARY

According to some embodiments, a system includes a processor circuit and a memory coupled to the processor circuit. The memory comprises machine readable instructions that, when executed by the processor circuit, cause the processor circuit to determine a cryptographic token associated with a player including a cryptographic hash associated with a blockchain, a player identifier indicative of a player associated with the cryptographic token; and a progress identifier indicative of a present progress value for a wagering game. The instructions further cause the processor circuit to determine a first progress value associated with a first play session of a first wagering game by a player. The instructions further cause the processor circuit to, based on the first progress value, modify the progress identifier of the cryptographic token to add the first progress value to the present progress value. The instructions further cause the processor circuit to, based on the present progress value, provide a first game benefit to the player.

According to some embodiments, a gaming device includes an input device, a processor circuit, and a memory coupled to the processor circuit, the memory comprising machine-readable instructions that, when executed by the processor circuit, cause the processor circuit to receive an instruction from the input device to initiate a first play session of a first wagering game by a player. The instructions further cause the processor circuit to conduct the first play session. The instructions further cause the processor circuit to determine a cryptographic token associated with a player comprising a cryptographic hash associated with a blockchain, a player identifier indicative of a player associated with the cryptographic token, and a progress identifier indicative of a present progress value for a wagering game. The instructions further cause the processor circuit to determine a first progress value associated with the first play session. The instructions further cause the processor circuit to, based on the first progress value, modify the progress identifier of the cryptographic token to add the first progress value to the present progress value. The instructions further cause the processor circuit to, based on the present progress value, provide a first game benefit to the player.

According to some embodiments, a method includes determining, by a processor circuit, a cryptographic token associated with a player including a cryptographic hash associated with a blockchain, a player identifier indicative of a player associated with the cryptographic token, and a progress identifier indicative of a present progress value for a wagering game. The method further includes determining, by the processor circuit, a first progress value associated with a first play session of a first wagering game by a player. The method further includes, based on the first progress value, modifying the progress identifier of the cryptographic token to add the first progress value to the present progress value. The method further includes, based on the present progress value, providing, by the processor circuit, a first game benefit to the player.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

FIG. 3 is a schematic block diagram illustrating various operations for a blockchain token transaction according to some embodiments.

FIGS. 4A-4C illustrate a graphical user interface (GUI) of a first game play session at a gaming device where game progress is stored on a cryptographic token, according to some embodiments.

FIGS. 5A-5C illustrate a GUI of a second game play session at another gaming device where stored game progress from the first game play session is applied to game progress at the second gaming device, according to some embodiments.

FIG. 6 is a flowchart illustrating operations of systems/methods of storing game progress in a cryptographic token, according to some embodiments.

### DETAILED DESCRIPTION

According to some embodiments, a cryptographic token may store game progress, e.g., toward a progressive bonus, from a wagering game session and apply the stored game progress to a subsequent wagering game session. For example, As used herein, cryptographic token refers to a digital or physical token containing machine readable code for authenticating the token and executing transactions using cryptographic techniques, such as via a blockchain, for example.

In some examples, individual game progress may be stored and/or associated with a cryptographic token being held by a player, which may be modified from game session to game session. For example, an EGM with a persistent progressive free games feature may have 50 free games as a potential progressive prize at the beginning of a player's play session. During the player's play session, 10 additional free games may be added to the potential prize. When the player leaves the EGM, some or all of the 10 additional free games may be removed from the EGM and stored in the cryptographic token. Later, when the player plays another wagering game, e.g., the same or similar title, the stored 10 free games may be added to the potential progressive prize at the new EGM, and the player can continue progressing towards the potential bonus award. Meanwhile, other players who do not have a cryptographic token, would add their progress to the EGM pool normally, with all of the progress remaining with the EGM at the end of their respective play sessions.

In some examples, a portion of the token holder's progress may remain with the EGM, to maintain appeal to a wider audience while still incentivizing the use of a cryptographic token to store some of the player's progress. One benefit of this arrangement is that the likelihood of players making small bets to try to win persistence pots may be reduced. For example, a player may initiate a game at a first EGM with a progressive pot value of $150. The player may increment the pot value by $10 during play and may store half (i.e. $5) in a cryptographic token, leaving the first EGM with a progressive pot value of $155 for a subsequent player. The player may then start a new game session at a second EGM with a progressive pot value of $100, adding the stored $5 to start the session with a progressive pot value of $105.

In some examples, progress may be stored in one or more cryptographic tokens, and may include different persistence levels based on different criteria, such as wager size, wager frequency, etc. For example, progress may be fully portable for a predetermined amount of time, and may disappear or decrement over time if the player does not initiate a new wagering game session or otherwise meet predetermined criteria within certain time periods. In some examples, different levels of tokens may have different decrement rates. In some examples, progress can be shared amount players, e.g., between family members, a group of friends, etc., and/or among players with a similar type of cryptographic token.

In some embodiments, a cryptographic token may increase in value over time with continued game play. For example, in a multi-level progressive game, a first session may not include any persistence feature, but as a certain gameplay threshold is reached, a first persistence feature may be unlocked, and persistence from the smallest progressive pot may be enabled. As play continues, persistence from the larger pots may be enabled over time.

In another example, a cryptographic token may be enabled on a game with a default Return to Player (RTP) percentage, i.e., a percentage of the total wagers that should be paid out to the players of the wagering game over time. Repeat play with the same token enabled on the same game achieving certain thresholds may allow the player to access paytables with higher RTP percentages and better rewards. These progress levels may be stored in the token such that the token may be transferred, e.g., sold, to a new user and may maintain the stored progress.

In some examples, the token may be a fungible token, i.e., interchangeable with respect to other tokens in a group or category of tokens, or a non-fungible token, i.e., non-interchangeable and unique. In some embodiments, after a certain threshold of game play or achievement, players can begin to earn game-related avatar traits that can be added to their token, and may convert a fungible token to a non-fungible token, that may be minted separately.

In some embodiments, persistence features may be enhanced when certain criteria are met. For example, persistence features may be improved during certain times, after a predetermined number of game sessions, or based on other criteria, e.g., by increasing or multiplying the stored persistence values during those times.

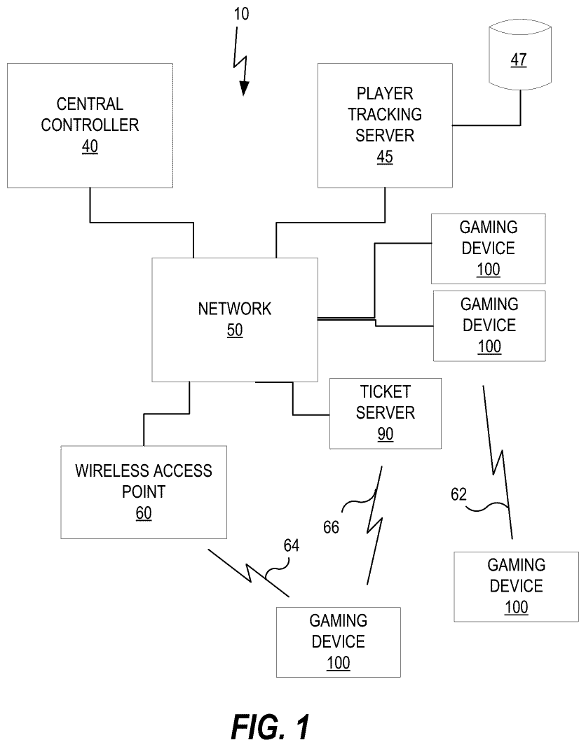

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

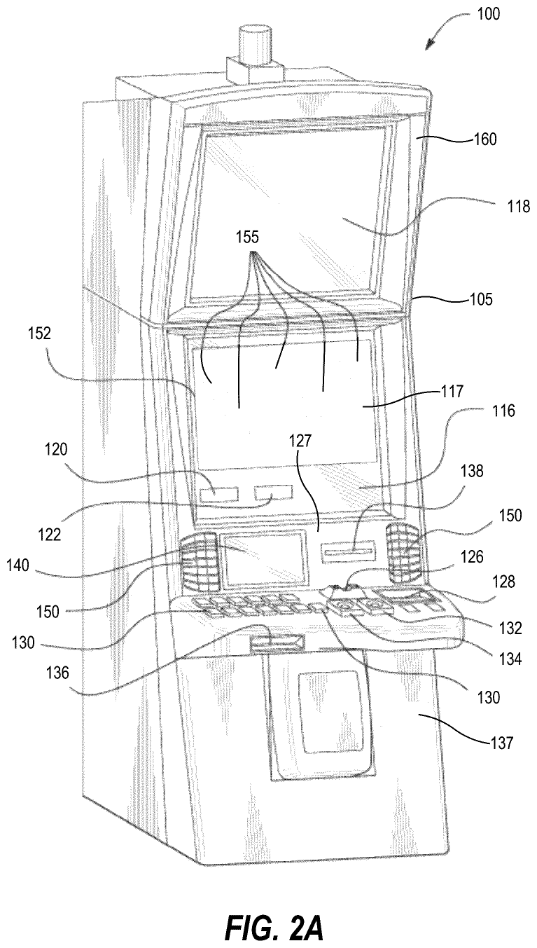

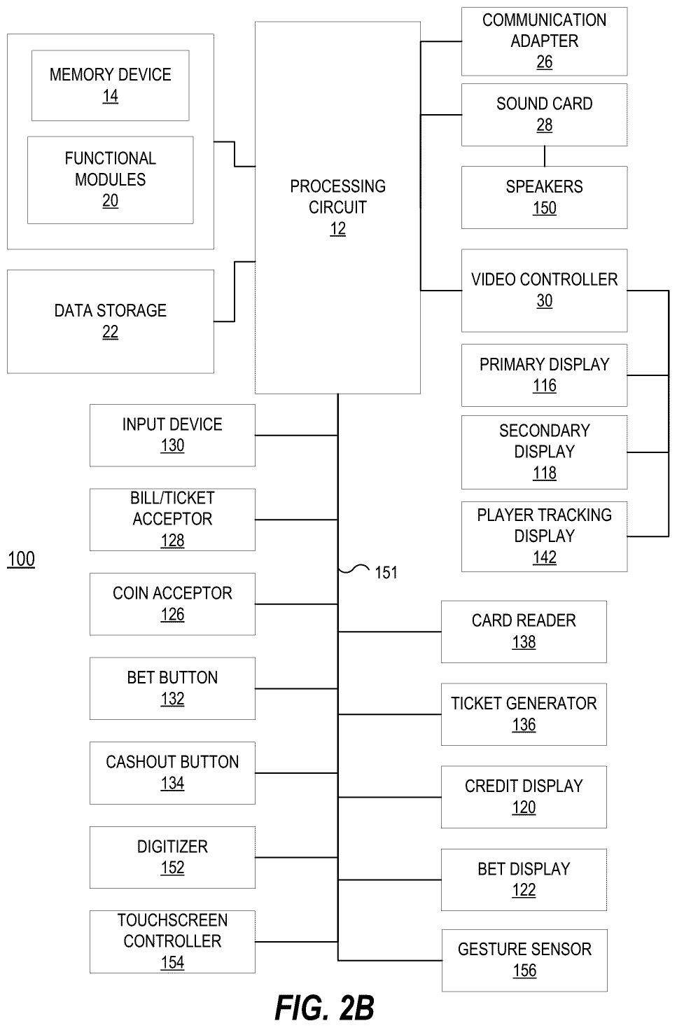

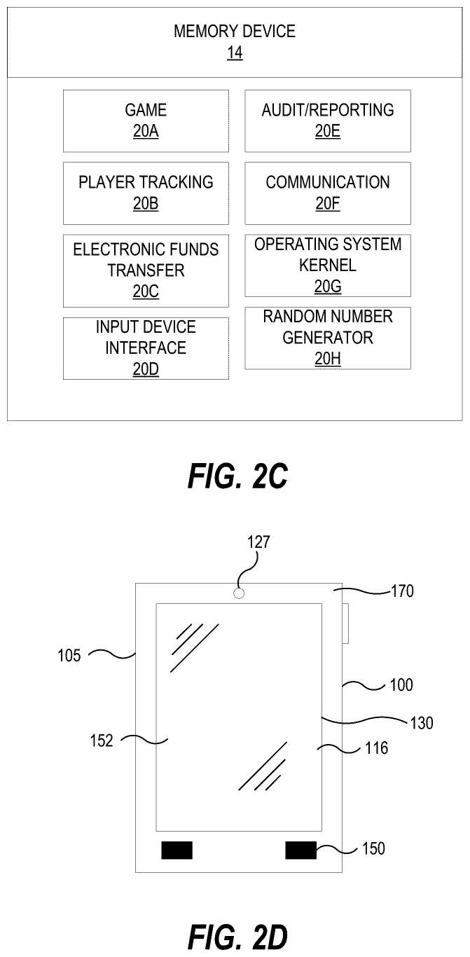

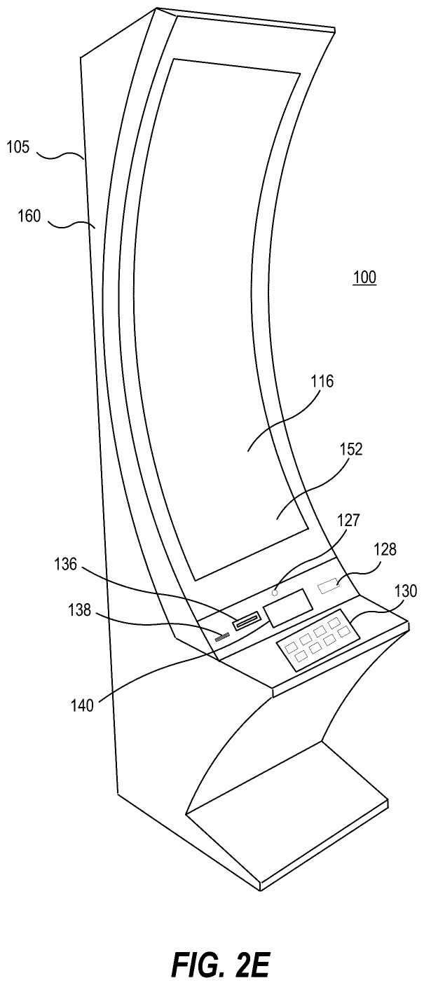

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

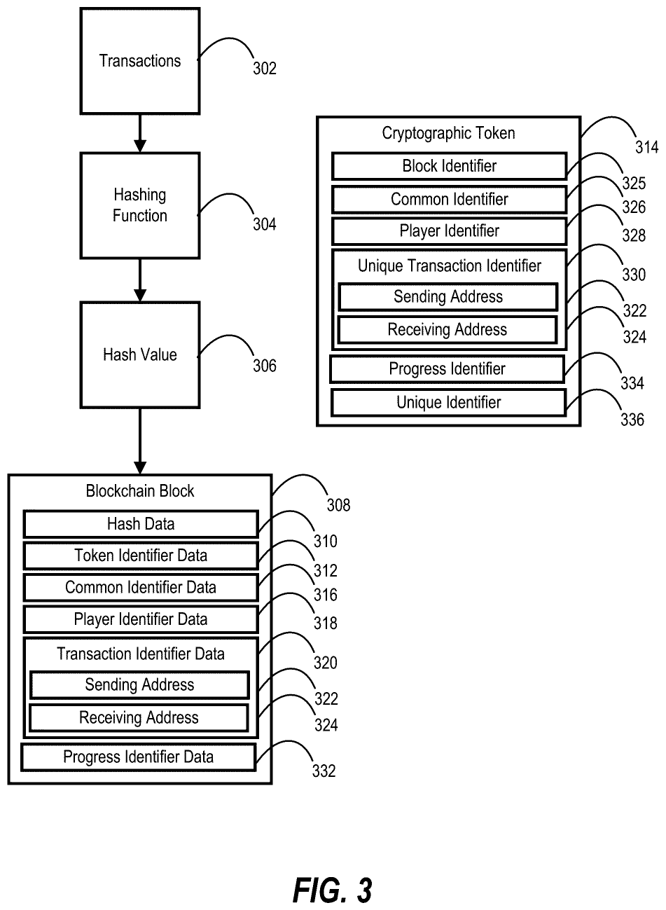

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Referring now to FIG. 3, a schematic block diagram illustrates various operations for a blockchain transaction recordation according to some embodiments. As illustrated in FIG. 3, transactions 302 may occur at various blockchain nodes. In accordance with various embodiments, a hash may be created for each entry. For example, a cryptographic hash function may create a one-way, (essentially) collision free signature of the entry. The hash algorithm generates a hash. Using hashing function 304, hash values 306 of these transactions are created and added to blockchain blocks 308 that are in the blockchain data structure.

In this example, each blockchain block 308 may include one or more different types of data. For example, each blockchain block 308 may include cryptographic hash data 310 indicative of a result of the hashing function 304 associated with a common blockchain, token identifier data 312 indicative of an identity of a cryptographic token 314 associated with the block 308, common identifier data 316 indicative of the cryptographic token 314 being part of a plurality of cryptographic tokens, e.g., a defined subset of tokens based on different criteria, associated with the common blockchain, player identifier data 318 indicative of an identity of a player associated with the cryptographic token 314, transaction identifier data 320 associated with the unique transaction on the blockchain, which may include a sending address 322 associated with a provider of the cryptographic token 314 and a receiving address 324 associated with the player identifier data 318.

The cryptographic token 314 may include some or all of the data structure of the respective associated block 308 and/or may contain a block identifier 325 referring to the associated block 308, which allows the cryptographic token 314 to be securely and transparently authenticated against the blockchain. In some examples, the cryptographic token 314 may include a common identifier 326 corresponding to the common identifier data 316 and indicative of the cryptographic token 314 being part of the plurality of cryptographic tokens, and a player identifier 328 corresponding to the player identifier data 318 and indicative of a player associated with the cryptographic token 314. The cryptographic token 314 may include a unique transaction identifier 330 associated with a unique transaction on the blockchain, i.e., a unique block 308, and may include the sending address 322 and/or the receiving address 324.

For example, a new transaction for the cryptographic token may include transmitting a transaction indication of the new transaction including a sending address 322 and receiving address 324, and, based on the transaction indication, modifying the player identifier data 318 in a new block 308 and/or the player identifier 328 of the cryptographic token 314 to be indicative of a different player.

In some examples, each block 308 may further include progress identifier data 332 associated with a progress identifier 334 of the cryptographic token 314 associated with a present or stored progress value for a wagering game. The wagering game may be a single wagering game title, or may be a group of wagering game titles. For example, a progressive pot may be associated with some or all game titles provided at a specific casino or group of casinos and/or by a specific game maker or group of game makers.

Each cryptographic token 314 may be a fungible token that is fungible with other cryptographic tokens, and/or may further include a unique identifier 336, which may correspond to the token identifier data 312 of the block 308, such that the cryptographic token 314 is a non-fungible token that is not fungible with other cryptographic tokens.

As a general principle, a validation process may be performed to ensure that each new blockchain block 308 meets the criteria for inclusion into the blockchain data structure. In a blockchain configuration, there are varying consensus algorithms that can be used. For example, a private blockchain may choose an algorithm such as Practical Byzantine Fault Tolerance (PBFT). The PBFT mechanism may be useful for small networks, such as networks having fewer than about 100 nodes. Other examples include a Proof of Work (PoW) consensus algorithm and/or a Proof of Stake (POS) consensus algorithm, which may be used as the value of an underlying data block and/or value changes.

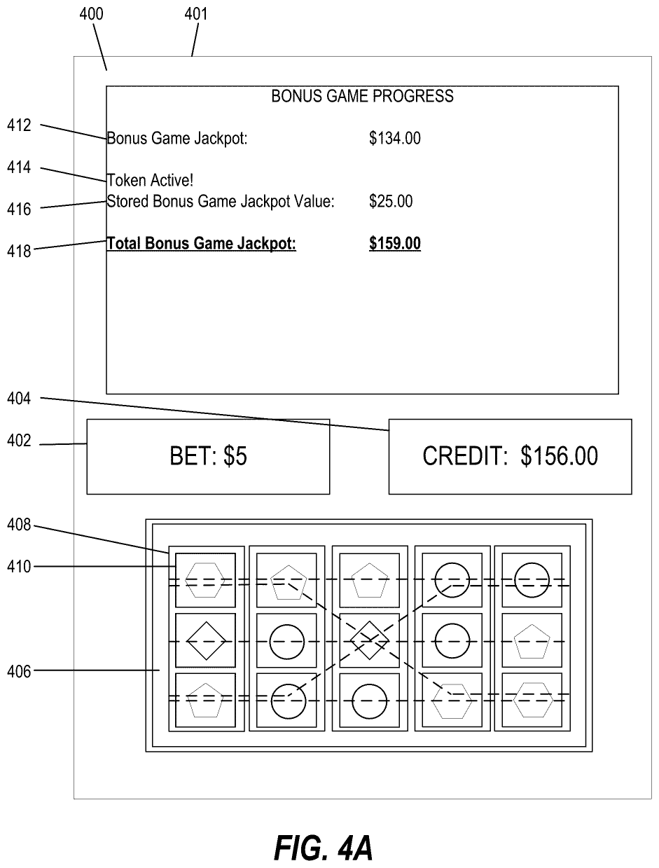

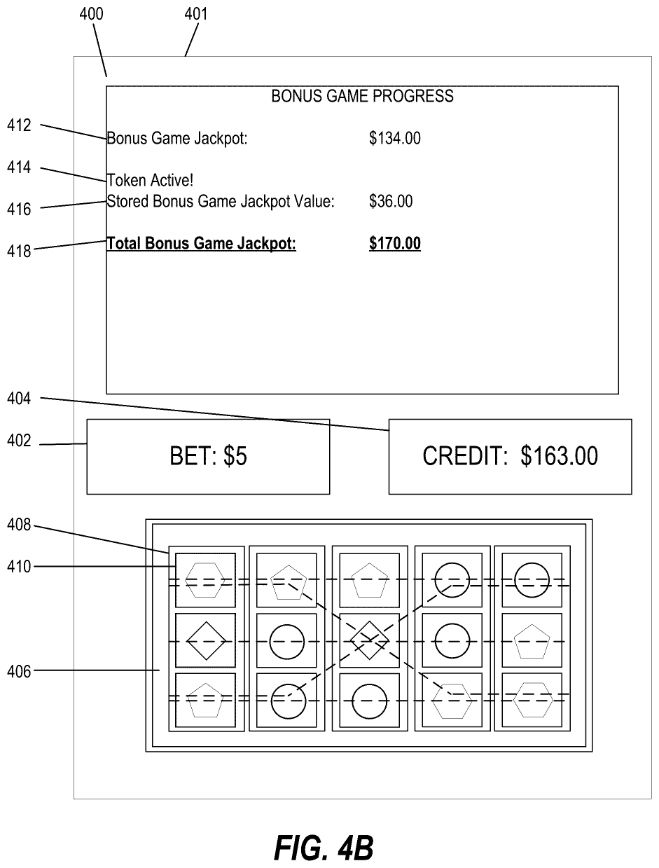

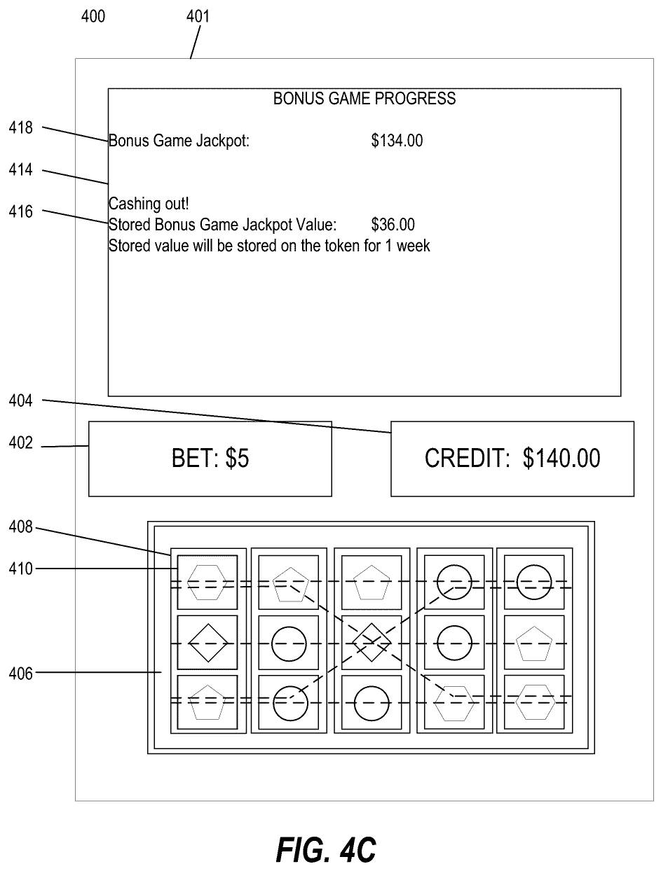

Referring now to FIG. 4A, a graphical user interface (GUI) 400 for a wagering game at a gaming device 401 is illustrated. The GUI 400 may include a bet button 402, a credit meter 404, and a plurality of game elements 406, such as a plurality of slot reels 408 and slot symbols 410 for example. In this example, the GUI 400 may further include an initial progress value 412 indicative of progress of the wagering game toward a goal, such as a progressive jackpot value at the beginning of a gaming session by the player.

In this example, a cryptographic token may be associated with the player, with the cryptographic token including a player identifier indicative of a player associated with the cryptographic token and a progress identifier indicative of a present progress value for the wagering game, such as a stored progress from a previous game session by the player. The GUI 400 may include a token indicator 414 indicating the stored progress value 416 which is added to the initial progress value 412 to provide a present progress value 418. In this example, the progress values are indicative of a progressive jackpot that grows over time based on play of the wagering game by a plurality of players, but it should be understood that the progress identifier can refer to any number of progress criteria, such as stored bonus games, unlockable game play features, a modified paytable, etc., as desired.

As shown by FIG. 4B, as game play continues, the present progress value 416 increases, and the additional progress may be added to the stored progress value 416 as well. In some examples, addition of the additional progress to the present progress value 418 and/or stored progress value 416 may be further based on a determination that a game activity threshold has been met by the player, such as a minimum bet denomination, rate of play, amount wagered, etc.

As noted above, in some examples, the cryptographic token may be fungible or non-fungible, as desired. In some embodiments, if the present progress value 418 reaches a predetermined threshold value, a unique identifier may be added to the cryptographic token such that the cryptographic token is a non-fungible token that is not fungible with a plurality of otherwise fungible tokens.

As shown by FIG. 4C, at the conclusion of the game session, some or all of the progress made during the session may be associated with the stored progress value 416, and the present progress value 418 at the gaming device may be reduced for the next game session by another player. In this manner, a player can store progress toward a progressive jackpot or other goal or game benefit across game sessions at different gaming devices. For example, the game benefit may include a number of stored bonus games for the wagering game, an increase in a progressive award pool, an unlockable game play feature of the first wagering game, modifying a paytable of the wagering game from a standard paytable to an enhanced paytable different from the standard paytable, and/or other benefit, as desired.

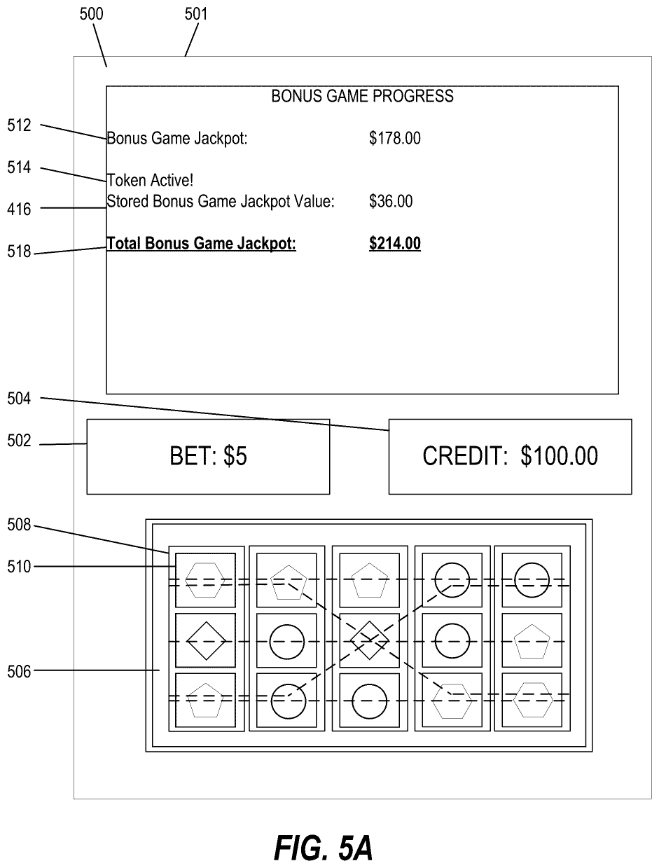

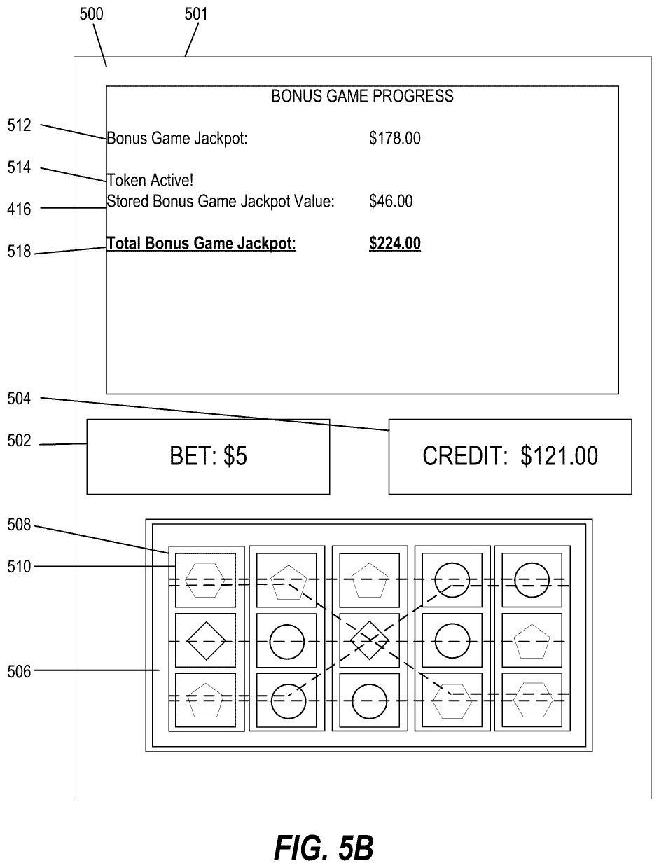

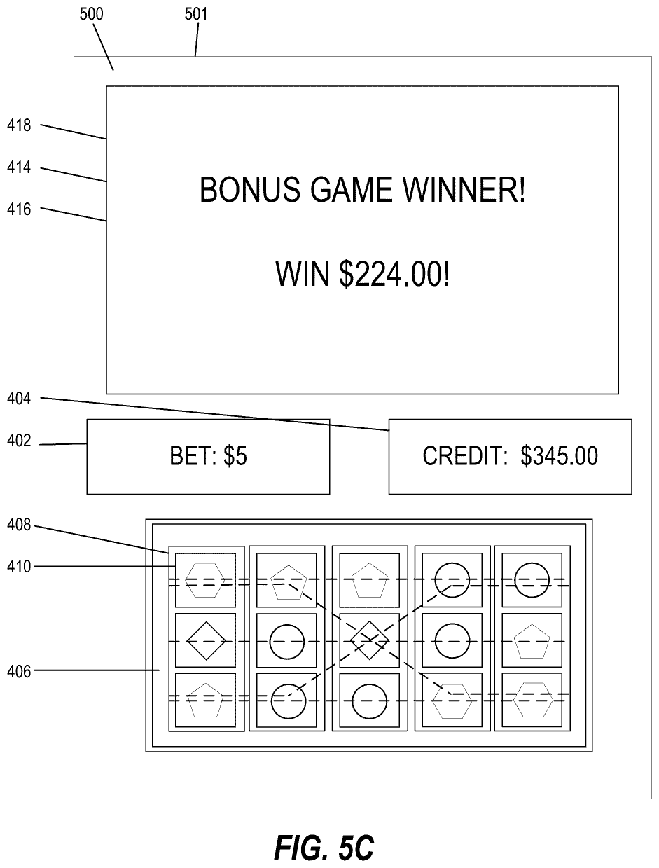

In this regard, as shown by FIG. 5A, a GUI 500 of another wagering game at a second gaming device 501 is illustrated. As with the wagering game of FIGS. 4A-4C, the GUI 500 includes a bet button 502, a credit meter 504, and a plurality of game elements 506, such as a plurality of slot reels 508 and slot symbols 510 for example, but it should be understood that the GUI 500 may include an entirely different wagering game, as desired. In this example, the wagering game is the same game as the wagering game of FIGS. 4A-4C, but it should be understood that the wagering game of FIGS. 5A-5C may be a different game from a predetermined group of games as well, such as or all game titles provided at a specific casino or group of casinos and/or by a specific game maker or group of game makers, as desired.

In this example, the second gaming device 501 includes its own initial progress value 512 toward a progressive jackpot award. In this example, the token indicator 514 also includes the stored progress value 416 from the game session of FIGS. 4A-4C, which is added to the initial progress value 512 to provide a present progress value 518. In this example as well addition of the stored progress value 416 to the initial progress value 512 may be further based on the player meeting an additional game activity threshold or other criteria, such as initiation of the second game session within a predetermined time period after the first game session, a predetermined total wager amount by the player in a predetermined time period, etc. In some examples, a determination that a game activity threshold has not been met by the player may cause a different progress value lower than the first progress value to be added to the present progress value, or may cause none of the stored progress value 416 to be added to the initial progress value 512. In some examples, failure to meet the game activity threshold may result in a reduction or loss of the stored progress value 416 as well. In some examples, a subsequent determination that the game activity threshold has been met by the player may cause the remaining stored progress value 416 to be added to the present progress value 518.

As shown by FIG. 5B, further progress during the game play session further increases the present progress value 518 and the stored progress value 416. As shown by FIG. 5C, if a progressive jackpot hits or a goal is otherwise reached, the present progress value 518 may be reduced to a base progress value 522, i.e., $0 in this example, and the stored progress value 418 may be similarly reduced to a base stored progress value 524, i.e., $0 in this example.

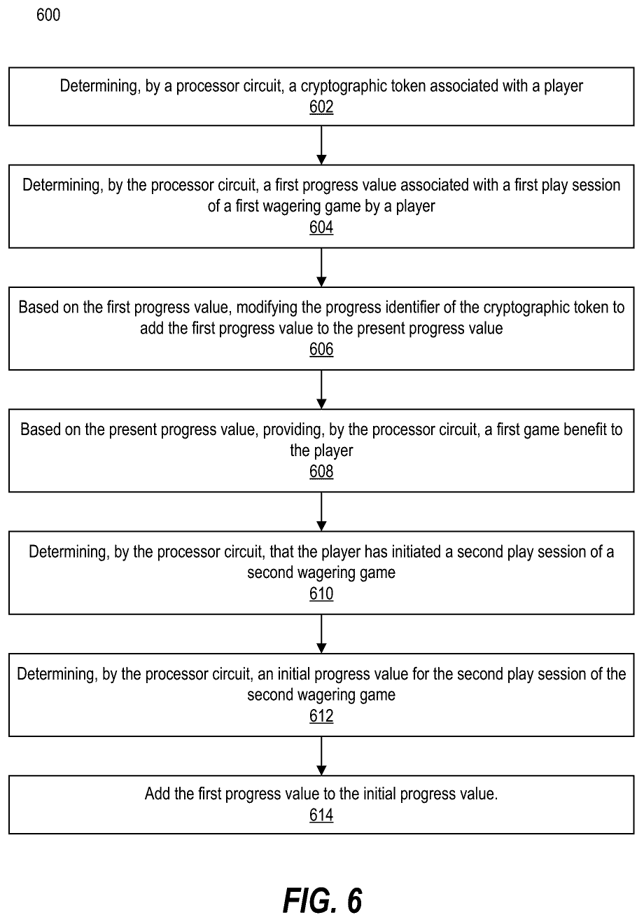

FIG. 6 is a flowchart illustrating operations 600 of systems/methods according to embodiments disclosed herein. The operations 600 may include determining, by a processor circuit, a cryptographic token associated with a player (Block 602). The cryptographic token may include a cryptographic hash associated with a blockchain, a player identifier indicative of a player associated with the cryptographic token, and a progress identifier indicative of a present progress value for a wagering game.

The operations 600 may further include determining, by the processor circuit, a first progress value associated with a first play session of a first wagering game by a player (Block 604), and based on the first progress value, modifying the progress identifier of the cryptographic token to add the first progress value to the present progress value (Block 606). Based on the present progress value, the operations 600 may further include providing, by the processor circuit, a first game benefit to the player (Block 608).

The operations 600 may further include determining, by the processor circuit, that the player has initiated a second play session of a second wagering game (Block 610). The operations 600 may further include determining, by the processor circuit, an initial progress value for the second play session of the second wagering game (Block 612) and adding the first progress value to the initial progress value (614).

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory coupled to the processor circuit, the memory comprising machine-readable instructions that, when executed by the processor circuit, cause the processor circuit to:
determine a cryptographic token associated with a player comprising:
a cryptographic hash associated with a blockchain;
a player identifier indicative of a player associated with the cryptographic token; and
a progress identifier indicative of a present progress value for a wagering game;
determine a first progress value associated with a first play session of a first wagering game by a player;
based on the first progress value, modify the progress identifier of the cryptographic token to add the first progress value to the present progress value; and
based on the present progress value, provide a first game benefit to the player.

2. The system of claim 1, wherein the instructions further cause the processor circuit to:
determine that the player has initiated a second play session of a second wagering game;
determine an initial progress value for the second play session of the second wagering game; and
add the first progress value to the initial progress value.

3. The system of claim 2, wherein the first wagering game is a different wagering game from the second wagering game.

4. The system of claim 2, wherein the first wagering game and the second wagering game are the same wagering game.

5. The system of claim 2, wherein the instructions further cause the processor circuit to:
determine a second progress value associated with the second play session of the second wagering game by the player;
based on the second progress value, modify the progress identifier of the cryptographic token to add the second progress value to the present progress value; and
based on the present progress value, provide a second game benefit to the player.

6. The system of claim 2, wherein addition of the first progress value to the present progress value is further based on a determination that a game activity threshold has been met by the player.

7. The system of claim 6, wherein the game activity threshold comprises initiation of the second play session within a predetermined time period after the first play session.

8. The system of claim 6, wherein the game activity threshold comprises a predetermined total wager amount by the player in a predetermined time period.

9. The system of claim 6, wherein a determination that a game activity threshold has not been met by the player causes a third progress value lower than the first progress value to be added to the present progress value.

10. The system of claim 9, wherein a subsequent determination that a game activity threshold has been met by the player causes a difference between the third progress value and the first progress value to be added to the present progress value.

11. The system of claim 1, wherein the first game benefit comprises a number of stored bonus games for the wagering game.

12. The system of claim 1, wherein the first game benefit comprises an increase in a progressive award pool.

13. The system of claim 1, wherein the first game benefit comprises an unlockable game play feature of the first wagering game.

14. The system of claim 1, wherein the first game benefit comprises modifying a paytable of the wagering game from a standard paytable to an enhanced paytable different from the standard paytable.

15. The system of claim 1, wherein the cryptographic token is a fungible token that is fungible with a plurality of fungible tokens.

16. The system of claim 15, wherein the instructions further cause the processor circuit to:
based on the present progress value reaching a predetermined threshold value, add a unique identifier to the cryptographic token such that the cryptographic token is a non-fungible tokens that is not fungible with a plurality of fungible tokens.

17. The system of claim 1, wherein the cryptographic token further comprises a unique identifier such that the cryptographic token is non-fungible tokens with any other cryptographic token of a plurality of cryptographic tokens.

18. A gaming device comprising:
an input device;
a processor circuit; and
a memory coupled to the processor circuit, the memory comprising machine-readable instructions that, when executed by the processor circuit, cause the processor circuit to:
receive an instruction from the input device to initiate a first play session of a first wagering game by a player;
conduct the first play session;
determine a cryptographic token associated with a player comprising:
a cryptographic hash associated with a blockchain;
a player identifier indicative of a player associated with the cryptographic token; and
a progress identifier indicative of a present progress value for a wagering game;
determine a first progress value associated with the first play session;
based on the first progress value, modify the progress identifier of the cryptographic token to add the first progress value to the present progress value; and
based on the present progress value, provide a first game benefit to the player.

19. The gaming device of claim 18, wherein the instructions further cause the processor circuit to:
determine that the player has initiated a second play session of a second wagering game;
determine an initial progress value for the second play session of the second wagering game; and
add the first progress value to the initial progress value.

20. A method comprising:
determining, by a processor circuit, a cryptographic token associated with a player comprising:
a cryptographic hash associated with a blockchain;
a player identifier indicative of a player associated with the cryptographic token; and
a progress identifier indicative of a present progress value for a wagering game;
determining, by the processor circuit, a first progress value associated with a first play session of a first wagering game by a player;
based on the first progress value, modifying the progress identifier of the cryptographic token to add the first progress value to the present progress value; and
based on the present progress value, providing, by the processor circuit, a first game benefit to the player.
